(19) United States
(12) Patent Application Publication
(10) Pub. No.: US 2024/0201836 A1
(43) Pub. Date: Jun. 20, 2024

(54) METHOD FOR MANAGING WINDOWS AND DISPLAY WINDOW MANAGER FOR A VIRTUAL WORKSTATION IN AN IMMERSIVE ENVIRONMENT, METHOD FOR MANAGING AN IMMERSIVE ENVIRONMENT AND IMMERSIVE REALITY SYSTEM

(71) Applicant: ORANGE, Issy-les-Moulineaux (FR)

(72) Inventors: Delphine Guegan, CHATILLON CEDEX (FR); Christine Kuster, CHATILLON CEDEX (FR); Maxime Jouin, CHATILLON CEDEX (FR); Sébastien Chevallier, CHATILLON CEDEX (FR)

(21) Appl. No.: 18/541,616

(22) Filed: Dec. 15, 2023

(30) Foreign Application Priority Data
Dec. 16, 2022 (FR) 2213649

(51) Int. Cl. G06F 3/04847; G06F 3/04815; G06F 3/0486

(52) U.S. Cl. CPC G06F 3/04847; G06F 3/04815; G06F 3/0486

(57) ABSTRACT

A method for managing display windows of a virtual workstation in an immersive environment, a display window being associated with a processing reproducing data produced by the associated processing. The method for managing windows includes setting a parameter for reproducing a display window, during a modification of the display window, to a value that is determined as a function of a current user context. Thus, the display window that is configured as a function of the current user context is notably positioned and sized so that the user can read the menus, data, etc. displayed thereon without any conscious effort, which reduces risk of any interaction errors and of musculoskeletal disorders.

### CROSS-REFERENCE TO RELATED APPLICATION

The present application claims priority to and the benefit of French Patent Application No. FR2213649, filed Dec. 16, 2022, the content of which is hereby incorporated by reference in its entirety.

### TECHNICAL FIELD

The present disclosure relates to managing the display windows for a virtual workstation in an immersive environment, in particular for virtual reality or augmented reality.

### PRIOR ART

Transposing a workstation into virtual or augmented reality, or virtualizing office tools, provides the user with the possibility of accessing a virtualized workstation, also called virtual office, even without a computer (PC or laptop) and/or screen, notably solely by virtue of the use of virtual and/or augmented reality glasses, and optionally of their smartphone.

The user then has greater variability with respect to the organization of their workstation, since this space is then extended three-dimensionally. Thus, information can be distributed all around the user.

However, arranging information in the three-dimensional space, in particular the various office windows when the user is unable to move and notably to rotate around their vertical axis, can cause musculoskeletal disorders (MSDs) and/or generate interaction errors because access to some information proves to be difficult for the user due to their positions in the three-dimensional space.

In particular, while a user standing up in an uncluttered environment can easily move by turning around on themselves, they will not be able to do so in a seated position (fixed seat) or in a real cluttered environment. As they are restricted by their position, and respectively by their real environment, they will tend to turn their head in order to manipulate a side window, thereby risking creating prolonged torsion of the cervical vertebrae, leading to neck pain or even headaches, neuralgia or cervical disorders in the long term. This is the case without considering the fact that, despite turning their head to the maximum of their physical capabilities, part of the side window can escape their field of vision, resulting in partial reading of the information in the side window and therefore erroneous interaction therewith.

Similarly, the three-dimensional display can lead to extreme positioning (very high, very low) of the windows, in particular of the frequently used windows, which again can lead to uncomfortable postures or even errors in interaction therewith since it is difficult for the user to read the information reproduced thereon.

### SUMMARY

An exemplary aspect of the present disclosure makes improvements over the prior art.

One aspect of the disclosure is a method for managing display windows of a virtual workstation in an immersive environment, a display window being associated with a processing reproducing data produced by the associated processing, the method for managing windows comprising setting a parameter for reproducing a display window, during a modification of the display window, to a value that is determined as a function of a current user context.

Thus, the display window that is configured as a function of the current user context is notably positioned and sized so that the user can read the menus, data, etc. displayed thereon without any conscious effort, which reduces the risk of any interaction errors and of musculoskeletal disorders.

Advantageously, the method for managing windows comprises determining the value of the parameter for reproducing the display window being modified as a function of the current user context.

Advantageously, the method for managing windows comprises determining the value of the parameter for reproducing the display window being modified as a function of a set reproduction zone, in which a reproduction of a display window of the virtual workstation is subject to a reproduction rule, the set reproduction zone depending on the current user context.

Thus, the display windows can be drawn to specific set reproduction zones and/or the set reproduction zones can be reproduced, reducing the modifications to the display windows that are requested by the user but are not carried out.

Advantageously, the method for managing windows comprises determining a set reproduction zone as a function of the current user context prior to the determining of the value of the parameter for reproducing the display window being modified.

Advantageously, the reproduction rule associated with a set reproduction zone is a rule from among the following rules:
an authorization for reproducing display windows in the set reproduction zone, called authorized zone;
a prohibition for reproducing display windows in the set reproduction zone, called prohibited zone;
a prioritization for reproducing display windows in the set reproduction zone, called ideal zone, as long as the set reproduction zone has enough free space for reproducing the display window;
a tolerance for reproducing display windows in the set reproduction zone, called tolerance zone, in which reproduction of a display window is authorized if the ideal zone does not have enough free space for reproducing the display window.

Advantageously, modifying the display window is a modification from among the following modifications:
opening the display window;
moving a display window;
resizing the display window.

Advantageously, the parameter for reproducing the display window is a parameter from among the following parameters:
the reproduction position of the display window;
the width of the display window;
the height of the display window;
the size of the display window.

Advantageously, the method for managing windows comprises measuring the current user context by means of at least one sensor.

Advantageously, the method for managing windows comprises requesting the current user context by means of a user interface and receiving the declared user context from the user interface.

Advantageously, the current user context comprises data relating to a user during the modification of the display window from among the following data:
declared data of the current user context;
measured data of the current user context;
position data of the user;
field of vision data of the user;
mobility data of the user;
data relating to the real environment in which the user is located.

A further aspect of the disclosure is a method for managing an immersive environment comprising a virtual workstation, the virtual workstation comprising a display window associated with a processing reproducing data produced by the associated processing, the method for managing an immersive environment comprising triggering a modification of a display window, the triggering of the modification of the display window triggering setting a parameter for reproducing a display window to a value that is determined as a function of a current user context prior to the reproduction of the modified display window.

Advantageously, according to one implementation of the disclosure, the various steps of the method according to an aspect of the disclosure are implemented by software or a computer program, this software comprising software instructions intended to be executed by a data processor of a device forming part of an immersive reality system and being designed to control the execution of the various steps of this method.

Therefore, the disclosure further relates to a program comprising program code instructions for executing the steps of the method for managing display windows and/or the method for managing an immersive environment when said program is executed by a processor.

This program can use any programming language and can be in the form of source code, object code or of intermediate code between source code and object code, such as in a partially compiled format or in any other desirable format.

A further aspect of the disclosure is a display window manager for a virtual workstation in an immersive environment, a display window being associated with a processing reproducing data produced by the associated processing, the display window manager comprising a regulator of parameters for reproducing the display window capable of setting, during a modification of a display window, a parameter for reproducing the display window to a value that is determined as a function of a current user context.

A further aspect of the disclosure is an immersive reality system comprising:
an immersive environment reproduction device;
a user context receiver; and
an immersive environment manager comprising a virtual workstation, the virtual workstation comprising a display window associated with a processing reproducing data produced by the associated processing, the immersive environment manager comprising a trigger for triggering the display window converter, the display window converter trigger being capable of triggering a regulator of parameters for reproducing the display window controller capable of setting a parameter for reproducing the display window to a value that is determined as a function of a current user context prior to the reproduction of the modified display window.

Advantageously, the user context receiver is a device from among the following devices:
a user interface of the immersive environment reproduction device;
a sensor.

### BRIEF DESCRIPTION OF THE DRAWINGS

The features and advantages of the disclosure will become more clearly apparent upon reading the description, which is provided by way of an example, and the related figures, which show:

FIG. 1a, a simplified diagram of the method for managing display windows of a virtual workstation in an immersive environment according to an aspect of the disclosure;

FIG. 1b, a simplified diagram of a phase for determining the value of a parameter for reproducing the display window w during modification in a particular embodiment of the method for managing display windows of a virtual workstation in an immersive environment according to an aspect of the disclosure;

FIG. 2, a simplified diagram of a method for managing an immersive environment according to an aspect of the disclosure;

FIG. 3, a simplified diagram of a display window manager for a virtual workstation in an immersive environment and of an immersive reality system according to an aspect of the disclosure;

FIG. 4a, a simplified diagram of an immersive environment in a particular use case implemented by a method for managing an immersive environment and/or an immersive reality system either in accordance with an aspect of the disclosure, or using a method for managing windows and/or a display window manager according to an aspect of the disclosure;

FIG. 4b, a simplified diagram illustrating set reproduction zones used in a particular embodiment of an aspect of the disclosure.

### DESCRIPTION OF THE EMBODIMENTS

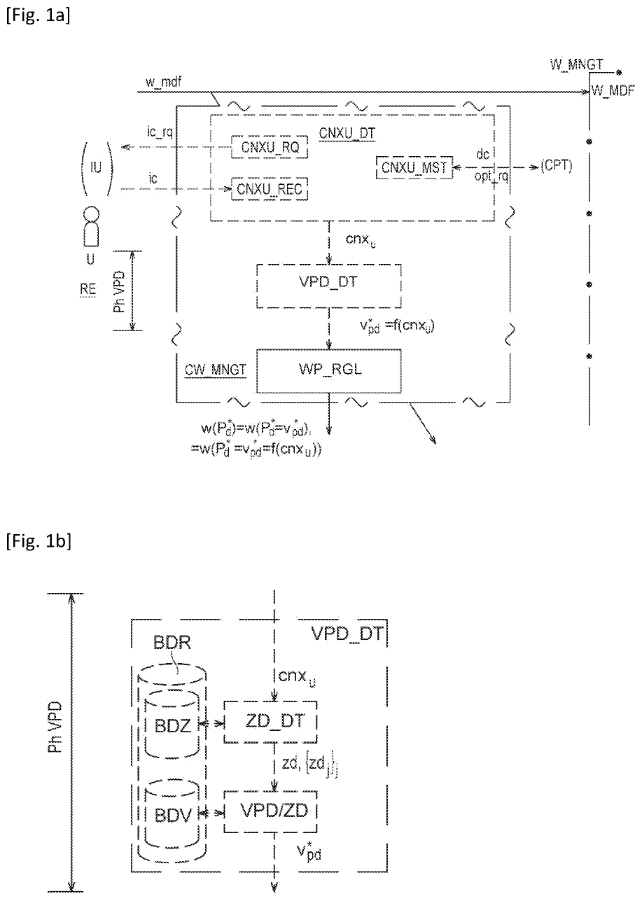

FIG. 1a illustrates a simplified diagram of the method for managing display windows of a virtual workstation in an immersive environment according to an aspect of the disclosure.

The method W_MNGT for managing display windows manages the display windows of a virtual workstation in an immersive environment. A display window is associated with a processing reproducing data produced by the associated processing. The method W_MNGT for managing windows comprises: setting WP_RGL a reproduction parameter pd, pd′ of a display window w, during a modification W_MDF of the display window, to a value pd*=v_{pd}* that is determined as a function of a current user context cnx_{U}.

In particular, the method W_MNGT for managing windows comprises: determining VPD_DT the value of the reproduction parameter pd*=v_{pd}* of the display window w being modified as a function of the current user context cnx_{U}.

In particular, modifying W_MDF the display window w is a modification from among the following modifications:
opening W_OP the display window w;
moving WP_MDF(pd′=f(pₚₒₛ′)) a display window w;
resizing WP_MDF(pd′=f(p_{dim}′)) the display window w.

In particular, the reproduction parameter pd, pd′ of the display window w is a parameter from among the following parameters:
the reproduction position pₚₒₛ, pₚₒₛ′ of the display window;
the width p_{L}, p_{L}′ of the display window;
the height pₕ, pₕ′ of the display window;
the size p_{dim}, p_{dim}′ of the display window.

In particular, the method W_MNGT for managing windows comprises: measuring CNXU_MST the current user context cnx_{U} by means of at least one sensor CPT.

In particular, the method W_MNGT for managing windows comprises, alternatively to or in combination with measuring CNXU_MST the user context cnx_{U}: requesting CNXU_RQ the current user context cnx_{U} by means of a user interface IU and receiving CNXU_REC the user context cnx_{U} as declared from the user interface IU.

In particular, the current user context cnx_{U} comprises data relating to a user U during modification W_MDF of the display window w from among the following data:
declared data ic of the current user context cnx_{U};
measured data de of the current user context cnx_{U};
position data of the user;
field of vision data of the user;
mobility data of the user;
data relating to the real environment in which the user is located.

Current user context is notably understood to mean one or more capabilities relating to the user: visual capability, mobility capability, etc., particularly linked to one or more physical constraints relating to the user, i.e., a constraint relating to at least one part of the body of the user: field of vision constraint, displacement constraint, movement constraint (arm, leg, head, etc.), etc.

Indeed, a user in a standing position context with no additional constraints is capable of turning around and therefore of seeing everything around them. However, as prolonged viewing of windows placed above a line placed at eye level can cause visual fatigue, the management method of an aspect of the disclosure will take this into account when setting the position of the windows below this line. Within the same context of a standing position with no additional constraints, interaction with low windows requiring the user to bend down can lead to musculoskeletal disorders linked to the repetition of these “low” interactions, i.e., with windows placed at a low height level.

Within another user context, for example, within a context of being in a seated position in a vehicle, the movement capability of the user is limited, and even more so if they are positioned next to a passenger, the bodywork of the vehicle, etc. Once again, as prolonged viewing of windows placed above a line placed at eye level can cause visual fatigue except in the case of a semi-recumbent seated position, the management method of an aspect of the disclosure will take this into account when setting the position of the windows below this line. Within this same position context, the management method will set the position of the windows above the seated height in order to take into account the fact that below this height the interaction of the user will be difficult or even impossible.

Furthermore, in the case of augmented reality, the current user context will include the position of the light source around the user (window, lamp, etc.). Thus, the management method will avoid positioning a window on the light source, or even next to it, limiting the risk of the user being dazzled by the light source, which could cause discomfort for the user, or even interaction errors.

The method W_MNGT for managing windows is implemented when a display window W_MDF of the virtual workstation of the immersive environment is modified. In particular, a request w_mdf to modify a display window w, wi triggering the modification W_MDF of the display window w, wi triggers the implementation of the method W_MNGT for managing windows for this display window w, wi.

In particular, the method W_MNGT for managing windows includes determining CNXU_DT a user context cnx_{U}.

The user context cnx_{U} is notably determined as a function of measured data dc provided, for example, by a sensor CPT, notably such as a sensor implemented in a device for reproducing an immersive environment (notably the virtual reality glasses worn by the user), the immersive environment manager (for example, the smartphone of the user), connected objects worn by the user (for example, a smartwatch), but also connected objects placed in the real environment RE of the user (for example, data provided by the vehicle or the room in which the user is located, etc.), etc. In particular, the method W_MNGT for managing windows comprises measuring CNXU_MST data relating to the user and/or their real environment by means of a sensor CPT. For example, the measuring step CNXU_MST involves receiving data dc that is captured either regularly or following a measurement request cpt_rq received by the sensor CPT, for example, from an immersive environment manager or directly from the measuring step CNXU_MST.

The user context cnx_{U} is notably determined as a function of data ic declared by the user U by means of a user interface IU (such as a keyboard, a joystick, a touch screen, a voice assistant, an interaction with the immersive environment manager, for example, by a gesture captured by a camera placed on virtual reality glasses or the use of a peripheral device such as a virtual reality joystick, etc.). In particular, the method W_MNGT for managing windows comprises receiving CNXU_REC the declared data ic of the user context, notably from a user interface IU. The user U declares data ic relating to the user context, notably following a request ic_rq for user context data reproduced by a user interface IU (such as the device for reproducing the immersive environment, a screen, notably the screen of a smartphone of the user U, a loudspeaker, etc.). In particular, the method W_MNGT for managing windows comprises requesting CNXU_REQ a declaration of user context data ic_rq, notably on a user interface IU.

In particular, determining CNXU_DT a user context cnx_{U} comprises one or more of the following steps:
measuring CNXU_MST data relating to the user and/or their real environment by means of a sensor CPT;
requesting CNXU_REQ a declaration of user context data ic_rq, notably on a user interface IU; and
receiving CNXU_REC the declared data ic of the user context, notably from a user interface IU.

In particular, the method W_MNGT for managing windows comprises determining a value of a reproduction parameter pd, pd′ of the display window w being modified, notably during a phase Ph VPD for determining the value of a reproduction parameter, with FIG. 1b illustrating a particular embodiment thereof.

In particular, the method W_MNGT for managing windows comprises determining VPD_DT the value of the reproduction parameter pd*=v_{pd}* of the display window w being modified as a function of the current user context cnx_{U}. Notably, determining VPD_DT the value of the reproduction parameter as a function of the current user context cnx_{U} is carried out during the phase Ph VPD for determining the value of a reproduction parameter. In particular, the current user context cnx_{U} used to determine the value of a reproduction parameter of the window w, wi being modified is provided by determining CNXU_DT a user context cnx_{U}, and/or measuring CNXU_MST data relating to the user and/or their real environment by means of the sensor CPT and/or receiving CNXU_REC the declared data ic of the user context, notably from a user interface IU.

The method W_MNGT for managing windows then provides a value of a reproduction parameter of the window w, wi being modified as a function of the current user context v_{pd}*=f(cnx_{U}), notably as an output from determining VPD_DT the value of the reproduction parameter as a function of the current user context cnx_{U} and/or of the phase Ph VPD for determining the value of a reproduction parameter.

The method W_MNGT for managing windows comprises: setting WP_RGL a reproduction parameter pd, pd′ of a display window w, during a modification W_MDF of the display window, to a value pd*=v_{pd}* that is determined as a function of a current user context cnx_{U}. In particular, setting WP_RGL the reproduction parameter pd, pd′ of the display window w uses the previously determined reproduction parameter value w(pd*)=w(pd*=v_{pd}*), notably during the phase Ph VPD for determining the value of a reproduction parameter and/or by determining VPD_DT the value of the reproduction parameter as a function of the current user context cnx_{U}: w(pd*)=w(pd*=v_{pd}*=f(cnx_{U})).

In particular, the method W_MNGT for managing windows comprises: contextually managing CW_MNGT a display window. The contextual management CW_MNGT of a display window depends on a user context cnx_{U}.

In particular, the contextual management CW_MNGT of a display window comprises setting WP_RGL a reproduction parameter pd, pd′ of a display window w, during a modification W_MDF of the display window, to a value pd*=v_{pd}* that is determined as a function of a current user context cnx_{U}. Optionally, the contextual management CW_MNGT of a display window further comprises one or more of the following steps:
determining CNXU_DT a user context cnx_{U};
measuring CNXU_MST data relating to the user and/or to their real environment by means of a sensor CPT;
requesting CNXU_REQ a declaration of user context data ic_rq, notably on a user interface IU;
receiving CNXU_REC the declared data ic of the user context, notably from a user interface IU;
the phase Ph VPD for determining the value of a reproduction parameter;
determining VPD_DT the value of the reproduction parameter as a function of the current user context cnx_{U}.

FIG. 1b illustrates a simplified diagram of the phase Ph VPD for determining the value of a reproduction parameter pd, pd′ of the display window w being modified in a particular embodiment of the method W_MNGT for managing display windows of a virtual workstation in an immersive environment according to an aspect of the disclosure.

In particular, the method W_MNGT for managing windows comprises: determining VPD/ZD the value of the reproduction parameter pd*=vpd* of the display window being modified as a function of a set reproduction zone zd, {zdⱼ}ⱼ, in which a reproduction of a display window w of the virtual workstation is subject to a reproduction rule rd, {rdⱼ}ⱼ, the set reproduction zone zd, {zdⱼ}ⱼ depending on the current user context cnx_{U}.

In a particular embodiment, determining VPD/ZD the value of the reproduction parameter involves consulting a reproduction parameter value database BDV or a reproduction rule database BDR as a function of the set reproduction zone. The reproduction parameter value database BDV or the reproduction rule database BDR comprises several rules for computing the reproduction parameter value associated with a reproduction rule. Depending on the set reproduction zone (in particular the reproduction rule for this set reproduction zone), determining the reproduction parameter value comprises: consulting the reproduction parameter value database BDV or the reproduction rule database BDR for the reproduction rule, reading therein the rule for computing the value of the reproduction parameter associated with this reproduction rule, executing the computation proposed by the rule for computing the value of the reproduction parameter as a function of the corresponding parameter of the reproduction zone and thus providing a reproduction parameter value.

In particular, the method W_MNGT for managing windows comprises: determining ZD_DT a set reproduction zone zd, {zdⱼ}ⱼ as a function of the current user context cnx_{U} of the reproduction parameter value pd*=vpd* of the display window being modified. Determining ZD_DT the set reproduction zone is notably carried out prior to the determining step VPD/ZD.

In a particular embodiment, depending on the current user context cnx_{U}, determining ZD_DT the set reproduction zone involves consulting a set reproduction zone database BDZ or a reproduction rule database BDR. The set reproduction zone database BDZ or the reproduction rule database BDR comprises several reproduction rules {rdⱼ}ⱼ associated with one or more geographical contexts cnx. For example, determining the set reproduction zone comprises: determining at least one geographical zone of the immersive environment corresponding to a given geographical context as a function of the user context cnx_{U}. The given geographical context corresponds to at least one of the geographical contexts associated with a reproduction rule in the set reproduction zone database BDZ or the reproduction rule database BDR. Then, depending on the geographical context corresponding to the geographical zone, determining the set reproduction zone comprises: consulting the set reproduction zone database BDZ or the reproduction rule database BDR depending on the geographical context associated with the determined geographical zone, reading therein the reproduction rule associated with the geographical context, associating the read reproduction rule with the determined geographical zone, thus providing a set reproduction zone comprising the determined geographical zone and the associated reproduction rule.

The geographical zone is notably defined by a position and optionally a dimension in the immersive environment, for example, a point corresponding to the top right-hand edge (possibly close to the user) for a rectangular type zone (respectively blocked) and a width, a height (respectively a depth) or a central point of the geographical zone and either a diameter for a circular or spherical geographical zone, or a diameter and a height for a cylindrical geographical zone, or a width, a height (respectively a depth) for a rectangular type zone (respectively blocked).

In particular, the reproduction rule rd, {rdⱼ}ⱼ associated with a set reproduction zone zd, {zdⱼ}ⱼ is a rule from among the following rules:
an authorization for reproducing display windows in the set reproduction zone, called authorized zone;
a prohibition for reproducing display windows in the set reproduction zone, called prohibited zone;
a prioritization for reproducing display windows in the set reproduction zone, called ideal zone, as long as the set reproduction zone has enough free space for reproducing the display window;
a tolerance for reproducing display windows in the set reproduction zone, called tolerance zone, in which reproduction of a display window is authorized if the ideal zone does not have enough free space for reproducing the display window.

For example, the one or more set reproduction zones can be provided by the user in the form of a user context declaration ic received CNXU_REC by the display window manager W_MNGT: ic=f(zd), either by the user drawing the boundaries of the declared set reproduction zone, or by the user selecting a shape and pointing to one or more points defining the position and the dimension of this shape forming the declared set reproduction zone, etc. The set reproduction zone declaration can be carried out following a request ic_rq optionally comprising the reproduction rule rd that will be associated with the set reproduction zone to be declared. Otherwise, the user can select and/or declare a reproduction rule during or directly after the definition of the reproduction zone.

In particular, determining VPD/ZD the value of the reproduction parameter pd*=v_{pd}* of the display window being modified as a function of a set reproduction zone zd, {zdⱼ}ⱼ uses the set reproduction zone zd, {zdj}j determined by determining ZD_DT set reproduction zone(s) zd, {zdⱼ}ⱼ as a function of the current user context cnx_{U}.

In particular, the method W_MNGT for managing windows comprises: determining VPD_DT the value of the reproduction parameter pd*=v_{pd}* of the display window being modified as a function of the current user context cnx_{U}.

In an alternative embodiment or in addition to the previous embodiment, determining VPD/ZD the value of the reproduction parameter and/or determining the set reproduction zone ZD_FT and/or determining the value of the reproduction parameter VPD_DT is carried out by the user learning, respectively, the configuration of the display windows as a function of one or more reproduced set reproduction zones, the user defining set reproduction zone(s) within a given user context cnx_{U}, the user configuring the display windows within a given user context cnx_{U}. It should be noted that the learning can be carried out prior to the use of the immersive environment, notably when configuring the management of the immersive environment, but also at any time when using the management of the immersive environment.

In an alternative embodiment or in addition to the previous embodiment, determining VPD/ZD the value of the reproduction parameter and/or determining the set reproduction zone ZD_FT and/or determining the value of the reproduction parameter VPD_DT is carried out by artificial intelligence.

A particular embodiment of the method for managing an immersive environment is a program comprising program code instructions for executing the steps of the method W_MNGT for managing display windows when said program is executed by a processor.

Depending on the use cases, the method W_MNGT for managing display windows comprises introducing visual elements notifying the user of the recommended ergonomic limits: ideal zones, tolerable zones, zones to be avoided, etc., for example, using one or more of the following steps:
highlighting recommendations for lateral and vertical limits (upper and lower) using visual pop-up windows;
forcing a window position to the position requested by the user (thus, an aspect of the disclosure provides the user with the option of defining the positions of their windows without compelling them);
storing the various layouts of the office space as a function of the context and redisplaying the office as pre-recorded according to the current context if the user so desires;
adapting the workstation if the user changes position or moves during a session (adaptation can be configured to be automatic or on request/validation by the user);
including eye-catching distant visual elements to encourage the user to relax visually (eye exercises).

An aspect of the disclosure thus guides the user to the best conditions for using the virtual workstation in the immersive environment.

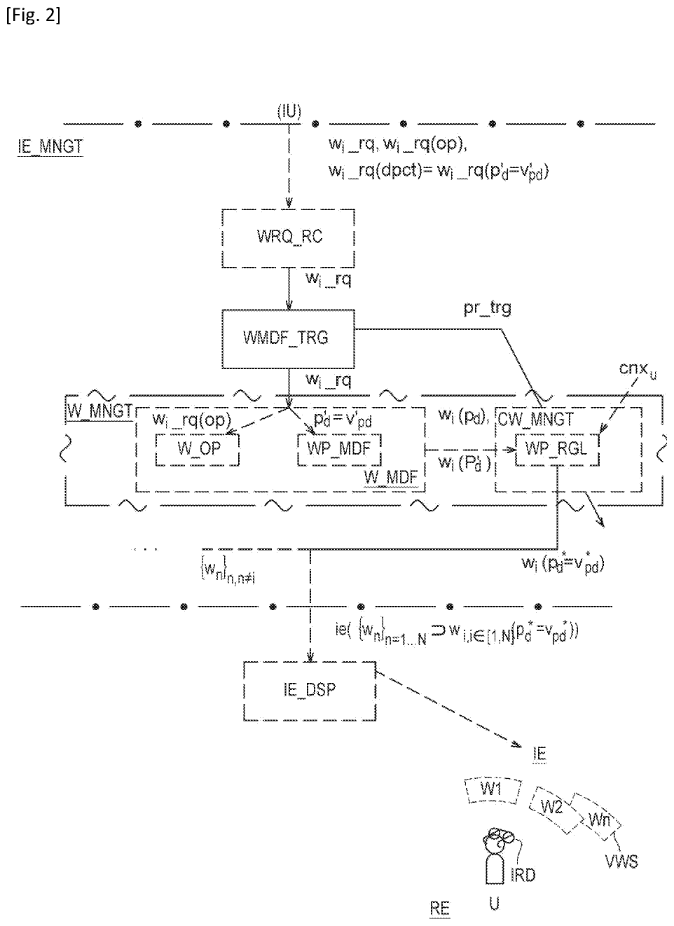

FIG. 2 illustrates a simplified diagram of a method for managing an immersive environment according to an aspect of the disclosure.

The method IE_MNGT for managing an immersive environment manages an immersive environment ie, IE, notably a virtual reality environment or an augmented reality virtual environment. The immersive environment IE comprises a virtual workstation VWS, itself comprising a display window W1, W2 . . . Wₙ associated with processing reproducing data produced by the associated processing. The method IE_MNGT for managing an immersive environment comprises: triggering WMDF_TRG a modification of a display window, triggering WMDF_TRG the modification of the display window, triggering pr_trg setting WP_RGL of a reproduction parameter pd, pd′ of a display window to a value that is determined as a function of a current user context cnx_{U} prior to the reproduction of the modified display window.

An immersive environment is understood to equally mean the immersive environment IE in which the user U and/or an avatar of the user U moves, namely a virtual 3D environment for virtual reality VR or augmented reality AR, i.e., the reproduced immersive environment, and, by misuse of language, the signal for reproducing the immersive environment ie, i.e., the signal received by an immersive reproduction device (3D glasses, AR glasses, VR glasses, holograph, etc.) that reproduces the reproduced immersive environment IE.

Similarly, a display window is understood to equally mean a display window W1, W2 . . . . Wₙ with which the user U and/or an avatar of the user U interacts, namely a virtual window of a virtual 3D environment for virtual reality VR or augmented reality AR, i.e., the reproduced display window, and, by misuse of language, the signal for reproducing the window w, {wₙ}ₙ, i.e., the signal received by an immersive reproduction device (3D glasses, AR glasses, VR glasses, holograph, etc.) that reproduces the reproduced display window W1, W2 . . . Wₙ.

In particular, the method IE_MNGT for managing an immersive environment comprises: receiving WRQ_RC a request wi_rq relating to a display window notably originating from a user interface IU, or even from a step of a method (not illustrated), such as the method IE_MNGT for managing an immersive environment, a processing management method (not illustrated) implementing processing associated with one of the display windows of the immersive environment IE, a method W_MNGT for managing display windows, etc.

In particular, the request wi_rq relating to a display window that is received by the method IE_MNGT for managing an immersive environment is notably a request wi_rq(op) to open a new display window associated with new processing or with processing currently being executed, a request wi_rq(dpct) to move a display window, optionally indicating the desired arrival position wi_rq(pd′=v_{pd}′), a request wi_rq(pd′=v_{pd}′) to set a reproduction parameter, optionally indicating the desired reproduction parameter value.

In particular, the reception WRQ_RC of a request wi_rq relating to a display window is sent to the trigger for triggering WMDF_TRG the modification of the display window that triggers pr_trg, as a function of the received request wi_rq relating to a display window, the setting WP_RGL of the parameter for reproducing the display window as a function of the user context cnx_{U}. In particular, triggering WMDF_TRG the modification of the display window relays the received request wi_rq relating to a display window to the method W_MNGT for managing windows in order to carry out the requested modification.

In particular, the display window management method W_MNGT comprises: modifying W_MDF the display window as a function of the received request wi_rq relating to a display window. Notably, display window management W_MNGT comprises: opening W_OP a display window as a function of a received request wi_rq(op) for opening a display window. Optionally, display window management W_MNGT comprises: modifying WP_MDF a reproduction parameter according to the request wi_rq(pd′=v_{pd}′). Modifying W_MDF the display window as a function of the received request wi_rq relating to a display window comprises, for example, one or more of the following steps:
opening W_OP a display window as a function of a received request wi_rq(op) for opening a display window;
modifying WP_MDF a reproduction parameter according to the request wi_rq(pd′=v_{pd}′).

In particular, the method W_MNGT for managing windows comprises: setting WP_RGL the reproduction parameter pd, pd′ of a display window w, during the modification W_MDF of the display window, to a value pd*=v_{pd}* that is determined as a function of a current user context cnx_{U}. Optionally, modifying W_MDF the display window provides parameters for reproducing the modified reproduction window wi(pd), wi(pd′) to the setting WP_RGL that sets one or more of these reproduction parameters as a function of the current user context cnx_{U}. The setting WP_RGL is then carried out after the modification W_MDF.

Thus, the setting WP_RGL can take into account the desired modification wi_rq. For example, if the requested position modification takes the display window to a position in which it will be difficult for the user to read, notably in a prohibited reproduction zone, then setting can involve searching for the acceptable position closest to the requested position (notably in an authorized or even tolerated reproduction zone) in order to move the display window.

In particular, the method W_MNGT for managing windows comprises: contextual management CW_MNGT of a display window. The contextual management CW_MNGT of a display window depends on a user context cnx_{U}. The contextual management CW_MNGT of a display window comprises setting WP_RGL a reproduction parameter pd, pd′ of a display window w, during a modification W_MDF of the display window, to a value pd*=v_{pd}* that is determined as a function of a current user context cnx_{U}.

The immersive environment ie then comprises all the unmodified display windows {wₙ}_{n,n≠i} and the one or more modified windows wi(pd*=v_{pd}*) for which at least one reproduction parameter has been set as a function of the user context cnx_{U}.

Either a method implemented by a reproduction device IRD distinct from the immersive environment manager implementing the method IE_MNGT for managing an immersive environment, or the method IE_MNGT for managing an immersive environment itself comprises: reproducing IE_DSP the immersive environment receiving the signal for reproducing the immersive environment ie comprising, if applicable, a modified window for which at least one reproduction parameter has been set as a function of the user context cnx_{U}.

A particular embodiment of the method WMDF_TRG for managing an immersive environment is a program comprising program code instructions for executing the steps of the method WMDF_TRG for managing an immersive environment when said program is executed by a processor.

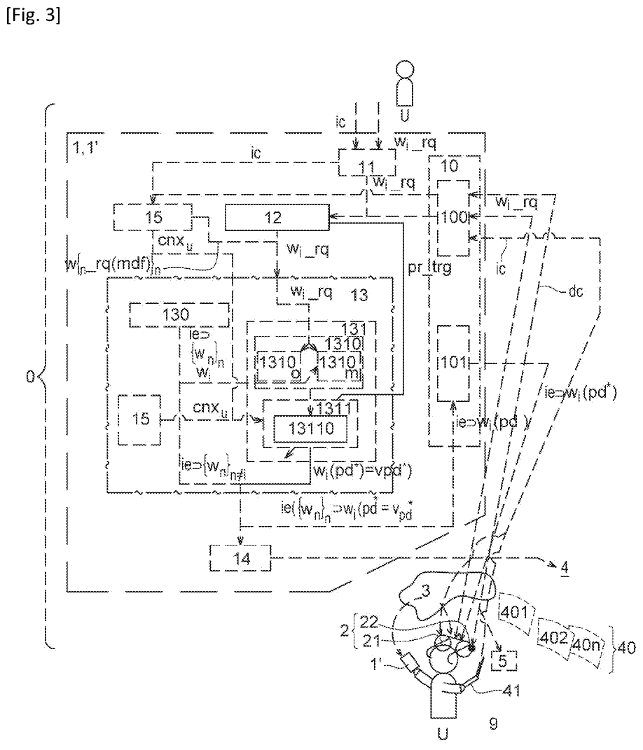

FIG. 3 illustrates a simplified diagram of a display window manager of a virtual workstation in an immersive environment and of an immersive reality system according to an aspect of the disclosure.

The display window manager 13 is able to manage display windows of a virtual workstation 40 in an immersive environment 4. A display window 401, 402 . . . 40n is associated with processing reproducing data produced by the associated processing. The display window manager 13 comprises a regulator 13110 for setting parameters for reproducing display windows capable of setting, during a modification of a display window, a reproduction parameter pd, pd′ of the display window to a value pd*=v_{pd}* that is determined as a function of a current user context cnx_{U}.

The display window manager 13 is used during a modification of a display window W_MDF of the virtual workstation of the immersive environment. In particular, a request w_mdf to modify a display window w, wi capable of triggering a display window w, wi converter 1310 triggers the implementation of the display window manager 13 for this display window w, wi.

In particular, the display window manager 13 comprises a context analyzer 15 capable of determining a user context cnx_{U}.

The user context cnx_{U} is notably determined as a function of measured data dc provided, for example, by a sensor 20, 5, notably such as a sensor 20 implemented in a device 2 for reproducing an immersive environment (notably the virtual reality glasses worn by the user), the immersive environment manager 1, 1′ (for example, the smartphone 1′ of the user), connected objects worn by the user (for example, a smartwatch), but also connected objects 5 placed in the real environment 9 of the user (for example, data provided by the vehicle or the room in which the user is located, etc.), etc. In particular, the window manager 13 comprises a device (not illustrated) for measuring data relating to the user and/or to their real environment 9 by means of sensors 20, 5. For example, the measuring device receives, notably by means of a receiver 100, data captured dc either regularly or following a measurement request (not illustrated) received by the sensor 20, 5, for example, from an immersive environment manager 1, 1′ or directly from the measuring device.

The user context cnx_{U} is notably determined as a function of declared data ic declared by the user U by means of a user interface 11, 21, 41, such as a keyboard 11, a joystick, a touch screen, a voice assistant, interaction with the immersive environment manager 1, 1′, for example, by a gesture captured by a camera 21 placed on virtual reality glasses or the use of a peripheral 41, such as a virtual reality joystick, etc. In particular, the window manager 13 comprises a receiver 11, 100 for receiving the declared data ic of the user context, notably the receiver is a user interface 11 or is able to receive from a user interface 21, 41. The user U declares data ic relating to the user context, notably following a request ic_rq for user context data reproduced by a user interface 2 (such as the device for reproducing the immersive environment, a screen, notably the screen of a smartphone of the user U, a loudspeaker, etc.). In particular, the window manager 13 comprises a request generator (not illustrated) capable of requesting a declaration of user context data ic_rq, notably from a user interface 2. For example, the window manager 13 comprises a transmitter 101 capable of transmitting the request generated by the request generator to the user interface 2.

In particular, the user context cnx_{U} analyzer 15 comprises one or more of the following devices:
the device for measuring data relating to the user and/or their real environment by means of sensors 20, 5;
the generator for generating requests for a declaration of the user context data ic_rq, notably on a user interface 2;
the receiver 11, 100 for receiving declared user context data ic, notably from a user interface 21, 41.

It should be noted that the sensors 20 and 21 of the immersive environment reproduction device 2 are either the same sensor or separate sensors.

In particular, the window manager 13 comprises a first computer (not illustrated) for computing a value of a reproduction parameter pd, pd′ of the display window w being modified, notably during a phase Ph VPD for determining the value of a reproduction parameter.

In particular, the window manager 13 comprises a second computer (not illustrated) for computing the value of the reproduction parameter pd*=v_{pd}* of the display window w being modified as a function of the current user context cnx_{U}. In particular, the second computer is capable of determining the value of the reproduction parameter as a function of the current user context cnx_{U} during the phase Ph VPD for determining the value of a reproduction parameter. In particular, the current user context cnx_{U} used by the second computer to determine the value of a reproduction parameter of the window w, wi being modified is provided by the user context cnx_{U} analyzer 15, and/or the device for measuring data relating to the user and/or to their real environment by means of sensors 20, 5 and/or the receiver 11, 100 for receiving declared data ic of the user context, notably from a user interface 21, 41.

Optionally, the first computer is made up of or comprises the second computer for computing the value of the reproduction parameter.

The window manager 13 then provides a value of a reproduction parameter of the window w, wi being modified as a function of the current user context v_{pd}*=f(cnx_{U}), notably as an output from determining VPD_DT the value of the reproduction parameter as a function of the current user context cnx_{U} and/or of the phase Ph VPD for determining the value of a reproduction parameter.

The window manager 13 comprises the regulator 13110 for setting reproduction parameters pd, pd′ of a display window w, during a modification of the display window, to a value pd*=v_{pd}* that is determined as a function of a current user context cnx_{U}. In particular, the regulator 13110 for setting reproduction parameters pd, pd′ of the display window w uses the previously determined reproduction parameter value w(pd*)=w(pd*=v_{pd}*), notably during the phase for determining the value of a reproduction parameter and/or by the second computer for computing the value of the reproduction parameter as a function of the current user context cnx_{U}: w(pd*)=w(pd*=v_{pd}*=f(cnx_{U})).

In particular, the window manager 13 comprises a contextual display window manager 1311. The contextual display window manager 1311 is capable of managing a display window as a function of a user context cnx_{U}.

In particular, the contextual display window manager 1311 comprises the regulator 13110 for setting reproduction parameters pd, pd′ of a display window w, during a modification of the display window, to a value pd*=v_{pd}* that is determined as a function of a current user context cnx_{U}. Optionally, the contextual display window manager 1311 further comprises one or more of the following devices:
the user context cnx_{U} analyzer 15;
the device for measuring data relating to the user and/or to their real environment by means of sensors 20, 5;
the generator for generating requests for a declaration of user context data ic_rq, notably on a user interface 2;
the receiver 11, 100 for receiving the declared data ic of the user context, notably from a user interface 21, 41;
the second computer for computing the value of the reproduction parameter as a function of the current user context cnx_{U}.

In a particular embodiment, an immersive environment manager 1 is capable of managing an immersive environment 4 comprising a virtual workstation 40. The virtual workstation 40 comprises a display window 401, 402 . . . 40n associated with processing reproducing data produced by the associated processing. The immersive environment manager 1 comprises a trigger 12 for triggering a display window converter 131. The trigger 12 for triggering the display window converter 131 is capable of triggering pr_trg a regulator 13110 for setting parameters for reproducing display windows capable of setting a reproduction parameter pd, pd′ of the display window to a value that is determined as a function of a current user context cnx_{U} prior to the reproduction of the modified display window.

In particular, a smartphone 1′ comprises the display window manager 13 and/or the immersive environment manager 1.

In a particular embodiment, an immersive reality system 0 is, notably, capable of generating and/or managing an immersive environment. The immersive reality system comprises:
an immersive environment ie reproduction device 2;
a user context cnx_{U} receiver 100, 11; and
an immersive environment manager 1.

The immersive environment manager 1 is capable of managing an immersive environment 4 comprising a virtual workstation 40. The virtual workstation 40 comprises a display window 401, 402 . . . 40n associated with processing reproducing data produced by the associated processing. The immersive environment manager 1 comprises a trigger 12 for triggering a display window converter 131. The trigger 12 for triggering the display window converter 131 is capable of triggering pr_trg a regulator 13110 for setting parameters for reproducing display windows capable of setting a reproduction parameter pd, pd′ of the display window to a value that is determined as a function of a current user context cnx_{U} prior to reproduction of the modified display window.

In particular, the user context cnx_{U} receiver 100 is a device from among the following devices: [symbol]
a user interface of the device 2 for reproducing an immersive environment;
a sensor 20, 5.

In particular, the various devices of the immersive reality system 0 communicate via a communication network 3.

In particular, the immersive environment manager 1 comprises a receiver 100 capable of receiving a request wi_rq relating to a display window notably originating from a user interface 21, or even from a device (not illustrated) such as the immersive environment manager 1 itself, a processing processor (not illustrated) implementing processing associated with one of the display windows of the immersive environment 40, a display window manager 13, etc.

In particular, the request wi_rq relating to a display window that is received by the immersive environment manager 1 is notably a request to open a new display window wi_rq(op) associated with new processing or with processing currently being executed, a request to move a display window wi_rq(dpct), optionally indicating the desired arrival position wi_rq(pd′=v_{pd}′), a request to set a reproduction parameter, optionally indicating the desired value of the reproduction parameter wi_rq(pd′=v_{pd}′).

In particular, the receiver 100 for receiving a request wi_rq relating to a display window is able to send it to a display window converter trigger 12 that is capable of triggering pr_trg, as a function of the received request wi_rq relating to a display window, the regulator 13110 for setting the parameter for reproducing the display window as a function of the user context cnx_{U}. In particular, the display window converter trigger 12 is able to relay the received request wi_rq relating to a display window to the display window manager 13 in order to carry out the requested modification.

In particular, the display window manager 13 comprises a converter 1310 for converting a display window as a function of a received request wi_rq relating to a display window. Notably, the display window manager 13 comprises: an opener 1310ₒ for opening a display window W_OP as a function of a received request wi_rq(op) to open a display window. Optionally, the display window manager 13 comprises: an elementary converter 1310ₘ for converting a reproduction parameter according to the request wi_rq(pd′=v_{pd}′). The converter 1310 for converting a display window as a function of a received request wi_rq relating to a display window comprises, for example, one or more of the following devices [symbol]
an opener 1310ₒ for opening a window as a function of a received request wi_rq(op) to open a display window;
an elementary converter 1310ₘ for converting a reproduction parameter according to the request wi_rq(pd′=v_{pd}′).

Optionally, the display window converter 1310 sends reproduction parameters for the modified reproduction window wi(pd), wi(pd′) to the regulator 13110 capable of setting one or more of these reproduction parameters as a function of the current user context cnx_{U}.

Thus, the regulator 13110 is, in particular, able to take into account the desired modification wi_rq. For example, if the requested modification in position takes the display window to a position in which it will be difficult for the user to read it, notably in a prohibited reproduction zone, the controller will be able to search for the acceptable position closest to the requested position (notably in an authorized or even tolerated reproduction zone) in order to move the display window.

The immersive environment ie then comprises all the unmodified display windows {wₙ}_{n,n≠i} and the one or more modified windows wi(pd*=v_{pd}*) for which at least one reproduction parameter has been set as a function of the user context cnx_{U}.

Either a reproduction device 2 separate from the immersive environment manager 1, or the immersive environment manager 1 itself comprises a device 2, 14 for reproducing the immersive environment capable of receiving the signal for reproducing the immersive environment ie comprising, if applicable, a modified window for which at least one reproduction parameter has been set as a function of the user context cnx_{U}.

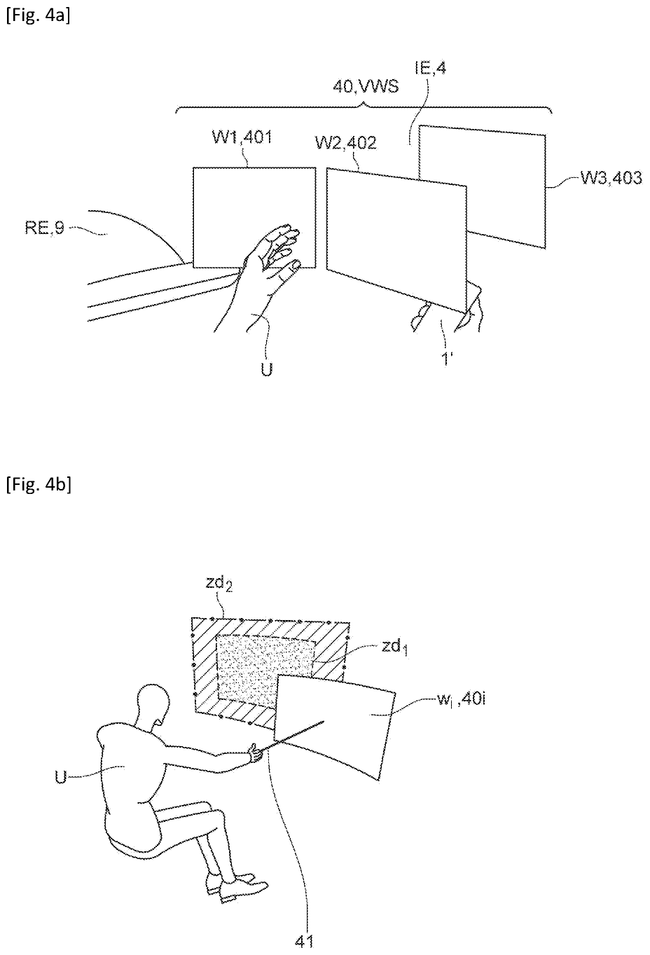

FIG. 4a illustrates a simplified diagram of an immersive environment in a particular use case implemented by a method for managing an immersive environment and/or an immersive reality system either according to an aspect of the disclosure, or using a method W_MNGT for managing windows and/or a display window manager according to an aspect of the disclosure.

The user U is in a real environment 9, RE, in this case a vehicle in the example of FIG. 4a. They do not have a real workstation there and they use their smartphone 1′ to generate and manage a virtual workstation 40, VWS in augmented reality. Thus, a device for reproducing augmented reality, for example, AR glasses (not shown), can be used to reproduce the virtual workstation 40, VWS, in this case comprising 3 display windows: W1, 401; W2, 402; W3, 403.

In their working position in the vehicle, the user U is seated and cannot stand up, move or turn around.

Consequently, if, when a new window is opened, the immersive environment management device uses the entire three-dimensional environment, this new window can be opened behind the back of the user, who is unable to see it and therefore to interact with it.

Another consequence relates to the type of interaction with the display windows. For example, in order to move a display window, the user can take one of the windows with their hand (for example, with a hand position that appears to be flat on the window) and then move it toward the desired location using an arm gesture. The risk is that, as the movement is poorly controlled, the window moves to the limit of the field of vision of the user, with it being understood that the user will have to perform physical efforts in order to face it (twist the torso and/or cervical vertebrae), yet with the risk of misreading the data displayed in this window, and/or of interaction errors since they are at the limit of the physical interaction zone (difficulty in positioning the arm or the hand correctly in order to interact with a specific element displayed by the display window, for example, an interaction element of a menu or a tab of the display window).

By using an aspect of the disclosure, this would not happen because the parameters for reproducing these open or moved windows would be set as a function of the user context, i.e., it would take into account the fact that the user can only read and/or interact in certain parts of the three-dimensional immersive environment, in this case in part of the three-dimensional immersive environment in front of the user with an angle of 40 to 60° on each side (effective field of vision) and at a predefined viewing height in front of the user specific to the user and to their position (sitting, standing, lying down, etc.).

FIG. 4b shows a simplified diagram illustrating the set reproduction zones used in a particular embodiment of the disclosure.

The illustrated set reproduction zones are as follows:
an ideal zone zd1, in which not only the reproduction of display windows is authorized and even preferred to another authorized reproduction zone as long as there is still enough space to open or move a display window therein;
a tolerance zone zd2, in which the reproduction of display windows is authorized (tolerated), notably if the ideal zone zd1 is full (i.e., if there is no more space to open or move a display window in the ideal zone zd1).

In the example shown in FIG. 4b, the user U moves a display window wi, 40i, notably by means of a peripheral interaction device 41. The new position of the display window wi, 40i requested by the user U. An aspect of the disclosure allows the parameters for reproducing this displaced display window wi, 40i to be set in such a way that the display window is displaced not to the requested position but either into the ideal zone zd1 (notably if there is still enough free reproduction space), or to the closest position optionally straddling the ideal zones zd1 and zd2. In this second case, this gives the user U the impression that the display window wi, 40i is drawn by the tolerance zone zd2.

It should be noted that, in the example shown in FIG. 4b, the tolerance zone zd2 includes the ideal zone zd1, but in other use cases this can involve separate zones.

Thus, an aspect of the disclosure proposes taking into account the context (physiognomic capabilities or disabilities of the user, position of the user, possibilities offered by the environment, etc.) and allowing the user to optimize the layout of the office space by taking into account this context. Depending on the position of the user and on their environment, the user therefore will be shown which areas are best for positioning windows (lateral limits, but also in terms of the bottom/top and distance/depth) for greater comfort and to avoid musculoskeletal or ophthalmic risks. In a particular use case, the indicated limits do not prevent the user from positioning windows within these limits, notably when these windows are used more occasionally.

Changes in the context of use (for example, transitioning from a seated to a standing position) will be either declarative or detected by the system.

Other use cases notably are as follows:

Situation 1: The user U is standing in an uncluttered environment with no-one nearby=>they place their workstation all around them (360°). Optionally, an aspect of the disclosure can determine a set reproduction zone of the preferred reproduction zone type that will move with each movement of the user in order to remain in front of them and correspond to the effective field of vision. Thus, when a new window is opened, it will open in this preferred reproduction zone if there is still enough space or close to it in order to prevent the user from making unnecessary movements searching for the new window.

Situation 2: The user U is standing but with limited space around them. For example, the user U is standing with their back to a wall. The recommended workstation is then limited to 180 degrees in order to avoid openings (windows, doors) on the wall side, for example. Thus, when an aspect of the disclosure uses a set reproduction zone, an aspect of the disclosure determines, for example, a prohibited reproduction zone on the wall side in which a display window cannot be reproduced. For example, if the user U requests a display window to be moved into this prohibited reproduction zone, everything happens as if the prohibited reproduction zone pushes the display window outside this prohibited reproduction zone.

Situation 3: The user U is sitting at a table/desk. An aspect of the disclosure sets the parameters for reproducing the display windows so that the workstation is then laterally at 90° maximum (or even only at 60° due to the effective field of vision), centered facing the user, and vertically along an axis, for example, “horizon−5°”/“horizon +30°”.

Situation 4: The user U is sitting on a sofa. In this case, an aspect of the disclosure sets the parameters for reproducing display windows so that the workstation has a vertical angle that is upwardly offset compared with the previous situation.

Situation 5: The user U is sitting on a train with the window to their right and a third party sitting on their left. An aspect of the disclosure sets the parameters for reproducing display windows so that the workstation is truncated on the left in order to prevent the person from looking to the left and encroaching the “bubble” of the third party.

Situation 6: The user U is a person with reduced mobility (with limited or no cervical mobility) in a motorized chair. An aspect of the disclosure sets the parameters for reproducing display windows so that the workstation takes into account the reduced effective field of vision of the user U.

Situation 7: When there is side lighting (window with sunlight in the frame), an aspect of the disclosure sets the parameters for reproducing display windows so that the user does not directly look at this lighting (the sunlight). For example, an aspect of the disclosure determines a prohibited reproduction zone comprising the space where the side lighting is located.

Changes in position (for example, from situation 1 to situation 3) cause an aspect of the disclosure to adapt (automatically or manually) the parameters for reproducing display windows of the workstation and, consequently, the workstation.

An aspect of the disclosure also relates to a medium. The information medium can be any entity or device capable of storing the program. For example, the medium can comprise a storage medium, such as a ROM, for example, a CD ROM or a microelectronic circuit ROM, or even a magnetic recording medium, for example, a floppy disk or a hard disk.

Moreover, the information medium can be a transmissible medium such as an electrical or optical signal that can be routed via an electrical or optical cable, by radio or by other means. In particular, the program according to an aspect of the disclosure can be downloaded from a network, notably of the Internet type.

Alternatively, the information medium can be an integrated circuit, in which the program is incorporated, the circuit being adapted to execute or to be used to execute the method in question.

In another implementation, an aspect of the disclosure is implemented by means of software and/or hardware components. For this purpose, the term module can equally correspond to a software component or a hardware component. A software component corresponds to one or more computer programs, one or more sub-programs of a program, or more generally to any element of a program or software capable of implementing a function or a set of functions as described above. A hardware component corresponds to any element of a hardware assembly capable of implementing a function or a set of functions.

1. A method performed by a management device and comprising:
managing at least one display window of a virtual workstation in an immersive environment, the display window being associated with a processing reproducing data produced by the associated processing, managing comprising:
setting a parameter for reproducing the display window, during a modification of the display window, to a value that is determined as a function of a current user context.

2. The method as claimed in claim 1, the method comprising determining the value of the parameter as a function of the current user context.

3. The method as claimed in claim 1, the method comprising determining the value of the parameter as a function of a set reproduction zone, in which a reproduction of a display window of the virtual workstation is subject to a reproduction rule, the set reproduction zone depending on the current user context.

4. The method as claimed in claim 3, the method comprising determining the set reproduction zone as a function of the current user context prior to the determining of the value of the parameter.

5. The method as claimed in claim 3, wherein the reproduction rule associated with the set reproduction zone is a rule from among the following rules:
an authorization for reproducing display windows in the set reproduction zone, called authorized zone;
a prohibition for reproducing display windows in the set reproduction zone, called prohibited zone;
a prioritization for reproducing display windows in the set reproduction zone, called ideal zone, as long as the set reproduction zone has enough free space for reproducing the display window;
a tolerance for reproducing display windows in the set reproduction zone, called tolerance zone, in which reproduction of a display window is authorized if the ideal zone does not have enough free space for reproducing the display window.

6. The method as claimed in claim 1, wherein modifying the display window is a modification from among the following modifications:
opening the display window;
moving the display window;
resizing the display window.

7. The method as claimed in claim 1, wherein the parameter for reproducing the display window is a parameter from among the following parameters:
a reproduction position of the display window;
a width of the display window;
a height of the display window;
a size of the display window.

8. The method as claimed in claim 1, wherein the method comprises: measuring the current user context by using at least one sensor.

9. The method as claimed in claim 1, wherein the method comprises requesting the current user context by using a user interface and receiving a declared user context from the user interface.

10. The method as claimed in claim 1, wherein the current user context comprises a user constraint.

11. The method as claimed claim 1, wherein the current user context comprises data relating to a user during the modification of the display window from among the following data:
declared data of the current user context;
measured data of the current user context;
position data of the user;
field of vision data of the user;
mobility data of the user;
data relating to a real environment in which the user is located.

12. A method implemented by a device and comprising:
managing an immersive environment comprising a virtual workstation, the virtual workstation comprising a display window associated with a processing reproducing data produced by the associated processing, the managing comprising:
triggering a modification of a display window, the triggering of the modification of the display window triggering setting a parameter for reproducing a display window to a value that is determined as a function of a current user context prior to the reproduction of the modified display window.

14. A display window manager device for a virtual workstation in an immersive environment, a display window being associated with a processing reproducing data produced by the associated processing, the display window manager device comprising:
at least one processor; and
at least one non-transitory computer readable medium comprising instructions stored thereon which when executed by the at least one processor configure the display window manager device to set a parameter for reproducing the display window, during a modification of the display window, to a value that is determined as a function of a current user context.

15. An immersive reality system comprising:
an immersive environment reproduction device;
a user context receiver; and
an immersive environment manager comprising a virtual workstation, the virtual workstation comprising a display window associated with a processing reproducing data produced by the associated processing, the immersive environment manager comprising a trigger for triggering a modification of the display window, the triggering of the modification of the display window triggering setting a parameter for reproducing the display window to a value that is determined as a function of a current user context prior to the reproduction of the modified display window.

16. The immersive reality system as claimed in claim 15, wherein the user context receiver is a device from among the following devices:
a user interface of the immersive environment reproduction device;
a sensor.
